(19) United States
(12) Patent Application Publication
(10) Pub. No.: US 2026/0209125 A1
(43) Pub. Date: Jul. 23, 2026

(54) REFRACTORY MATERIAL, METHOD FOR PRODUCING SAME, AND USE THEREOF

(71) Applicant: REFRACTORY INTELLECTUAL PROPERTY GMBH & CO. KG, Wien (AT)

(72) Inventors: Milos Blajs, Wien (AT); Bernhard Pribil, Wien (AT); Christoph Bauer, Wien (AT); Norbert Freiberger, Wien (AT); Bernd Trummer, Graz (AT); Johann Eder, Leoben (AT)

(21) Appl. No.: 19/141,239

(22) PCT Filed: Dec. 11, 2023
(86) PCT No.: PCT/EP2023/085068

§ 371 Date: Jun. 19, 2025

(30) Foreign Application Priority Data
Dec. 22, 2022 (EP) 22215799.2

(51) Int. Cl. C04B 35/56; C04B 35/624

(52) U.S. Cl. CPC C04B 35/5603; C04B 35/624; C04B 2235/3217; C04B 2235/3865; C04B 2235/3895; C04B 2235/402; C04B 2235/422; C04B 2235/5427; C04B 2235/602; C04B 2235/652

(57) ABSTRACT

The invention relates to a refractory material which is thermally treated at a temperature of at least 1300° C., preferably 1300° C. to 1750° C., such that the material has an acicular structure and a combination of a first phase, a second phase, and a third phase, wherein: the first phase comprises 2-10 wt. % C, <5 wt. % N, 30-40 wt. % O, 50-70 wt. % Al, and <5 wt. % Si, based on the total proportion of the first phase, the second phase comprises 1-7 wt. % C, 3-8 wt. % N, 25-35 wt. % O, 55-65 wt. % Al, and <5 wt. % Si, based on the total proportion of the second phase, and the third phase comprises <7 wt. % C, 14-28 wt. % N, 10-15 wt. % O, 52-63 wt. % Al, and <20 wt. % Si, based on the total proportion of the third phase, to a batch for producing the refractory material, to a main part produced from a batch, to a method for producing a refractory material, and to the use thereof.

The present invention relates to a refractory material, to a batch for producing a refractory material, to a green body produced from a batch, to a method for producing a refractory material, and to the use of such.

Refractory materials find their application in high-temperature industrial processes, for example, and are therefore required to remain stable even under adverse circumstances and at very high temperatures.

They are used for example in the steel industry, where they serve purposes including the manufacture of products such as functional articles (e.g., perforated blocks or impact absorbers) and/or of products for the provision and/or maintenance of steel ladles, tundishes and other metallurgical assemblies. Such metallurgical assemblies provided with products made from refractory materials are used in turn for holding and processing molten steel and other liquid metal products. Refractory materials therefore secure other substances and mixtures during their combustion, conversion, smelting, detonation, burning, melting and molding, and are therefore required to withstand thermal, mechanical and chemical loading.

It is therefore desirable to provide a refractory material having good physical properties, such as high strength and high thermal shock resistance, for example, that allows a host of different refractory products to be produced.

It is therefore an object of the present invention to provide a refractory material which has very good physical properties, such as, in particular, very good heat resistance and/or hot abrasion resistance, good thermal shock resistance, and low thermal conductivity. Moreover, it is also to be possible to be able to utilize the refractory material for a host of different refractory products, including in particular more complex cast products. A further object of the present invention, therefore, is for the refractory material with its advantageous properties to be obtainable starting from a batch which has advantageous processing properties, such as good flow properties in particular.

The invention achieves this object by means of a refractory material treated thermally at a temperature of at least 1300° C., preferably of 1300° C. to 1750° C., to have an acicular structure and to comprise a combination of a first phase, a second phase and a third phase, including the first phase, which comprises 2-10% by weight C, <5% by weight N, 30-40% by weight O, 50-70% by weight Al and <5% by weight Si, based on the total fraction of the first phase, the second phase, which comprises >1% by weight C, 3-8% by weight N, 25-35% by weight O, 55-65% by weight Al and <5% by weight Si, based on the total fraction of the second phase, the third phase, which comprises <7% by weight C, 14-28% by weight N, 10-15% by weight O, 52-63% by weight Al and <20% by weight Si, based on the total fraction of the third phase.

To begin with, a number of terms used in the context of the invention should be explained.

The term “refractory material” is used in the present application in the manner familiar to the skilled person from the prior art. It is accordingly a material which is fire-resistant and resistant to high temperature. The refractory material is preferably produced from inorganic raw materials. The material is able in particular to withstand high temperatures of at least 1500° C. or more without softening. The material preferably has a pyrometric cone equivalent of greater than SC 17 (=ISO 150), corresponding roughly to a temperature of 1500° C. (see DIN 51 060). The pyrometric cone equivalent can be determined according to ISO 528 and DIN EN 993-12. The material is therefore suitable for the possibility of contact with liquid metal products and steel products for a certain time period without itself losing its external shape.

In the context of the present invention, a “batch” is a shapeless or unshaped formulation which is used for producing the refractory material.

The term “green body” is used in the present application in the manner familiar to the skilled person from the prior art. It is accordingly a formulation which is molded or cast into shape, but unfired, and which is still easily worked.

In the context of the present invention, a “phase” is a spatial region in a solid body which differs both chemically and morphologically (i.e., in shape, form and structure) from its surroundings.

The first phase preferably comprises 2-10% by weight C, 0.001-5% by weight N, 30-40% by weight O, 50-70% by weight Al and 0.001-5% by weight Si, based on the total fraction of the first phase.

The second phase preferably comprises 1-7% by weight C, 3-8% by weight N, 25-35% by weight O, 55-65% by weight Al and 0.001-5% by weight Si, based on the total fraction of the second phase.

The third phase preferably comprises 0.001-7% by weight C, 14-28% by weight N, 10-15% by weight O, 52-63% by weight Al and 0.001-20% by weight Si, based on the total fraction of the third phase.

In accordance with the invention, the refractory material comprises a combination of the first phase, the second phase and the third phase.

In accordance with the invention, the first phase preferably comprises Al₄O₄C or consists of Al₄O₄C.

In accordance with the invention, further, the second phase preferably comprises Al₂₈C₆N₆O₂₁ or consists of Al₂₈C₆N₆O₂₁.

In accordance with the invention, further, the third phase preferably comprises SiAl₆O₂N₆.

In accordance with the invention, preferably, the third phase comprises a compound selected from SiAl₆O₂N₆, SiAl₅O₂N₅, SiAl₄O₂N₄, Si₃Al₇O₃Ng and mixtures thereof. The third phase preferably comprises SiAl₆O₂N₆.

In accordance with the invention, further, the third phase consists of a compound selected from SiAl₆O₂N₆, SiAl₅O₂N₅, SiAl₄O₂N₄, Si₃Al₇O₃Ng and mixtures thereof.

The refractory material may comprise a fourth phase, in which case the fourth phase comprises <5% by weight C, 26-36% by weight N, <8% by weight O, 56-66% by weight Al and <5% by weight Si, based on the total fraction of the fourth phase, and the fourth phase preferably comprises AlN or consists of AlN.

Further, the fourth phase may comprise 0.001-5% by weight C, 26-36% by weight N, 0.001-8% by weight O, 56-66% by weight Al and 0.001-5% by weight Si, based on the total fraction of the fourth phase.

The presence of the acicular (needle) structure or of phases with acicular structure may be determined preferably via scanning electron microscopy.

The composition of the phases is determined preferably via scanning electron microscopy (SEM), with an excitation voltage of 10 kV and a probe current of 1 nA, using an energy-dispersive detector.

The acicular structure preferably comprises needles with a length in a range of 0.1-50 μm, preferably 0.1-30 μm, more preferably 2-30 μm and/or with a thickness in a range of 0.01-8 μm, preferably 0.2-5 μm, measured via scanning electron microscopy, with an excitation voltage of 10 kV and a probe current of 1 nA.

A minimal ratio of lengths to thicknesses (at least for some) of the needles is preferably at least 4:1. Preferably at least 20%, more preferably at least 40%, of the needles of the acicular structure have a minimal ratio of the lengths to thicknesses of at least 4:1. Preferably at least 20%, more preferably at least 40%, of the needles of the acicular structure in a region of at least 1000 μm×1000 μm have a minimal ratio of the lengths to thicknesses of the needles of at least 4:1. This may be determined via scanning electron microscopy, with an excitation voltage of 10 kV and a probe current of 1 nA.

The refractory material further preferably comprises holelike structures (or structures which appear circular on polished sections). The holelike structures or structures of circular appearance preferably comprise a (predominant) portion of the acicular structures. In one preferred embodiment, a (predominant) portion of the needles are formed at the surfaces of the holelike structures or structures of circular appearance.

In accordance with the invention, preferably, a proportion of the phases with acicular structure is at least 0.01% by weight, preferably 0.1% by weight, based on the total fraction of the refractory material.

The refractory material preferably has an open porosity in a range of 10.0-25.0% by volume, measured according to DIN EN ISO 1927-6, and/or a bulk density in a range of 2.95-3.70 g/cm³, measured according to DIN EN ISO 1927-6.

The refractory material preferably comprises refractory functional articles, more preferably refractory casting and/or pressing products, even more preferably refractory products in the flow control sector, more preferably still slide gate plates, collector nozzles, shrouded tubes, stoppers, submerged tubes, inner nozzles, weirs, dams, impact absorbers and other nozzles. In the context of the present invention, the term “functional product” is to be understood to mean a product that is manufactured partly or entirely from the refractory material and has been shaped by casting and/or molding.

The invention has the advantage that the refractory material of the invention has very good physical properties. In particular, for example, the refractory material exhibits very good heat resistance/hot abrasion resistance and at the same time very good thermal shock resistance. The refractory material of the invention is resistant to high temperature and is able to withstand temperatures of at least 1700° C. without softening. It has an acicular structure with very stable phases which form in situ. The fine needles, which form in many regions of the material, are very likely responsible for the good thermal shock resistance.

In addition, the refractory material of the invention displays low thermal heat conductivity. This not only has the advantage that the refractory material has good insulation properties but also results in an improvement in the pouring capacity of the products obtained from the refractory material. The reason is that, owing to low thermal heat conductivity of the material, the accumulation of solid constituents or particles on the refractory material, i.e., unwanted clogging, is avoided.

A further subject of the invention is a batch for producing a refractory material of the invention, preferably as claimed in any of claims 1 to 8, wherein the batch comprises the following constituents:
a) granular component as a coarse fraction having a particle size in a range of 0.5-10 mm, selected from MA spinel, sintered alumina, high-grade «-alumina, brown α-alumina, gray α-alumina, mullite, bauxite, andalusite, SiC, grog, zirconium-containing components and mixtures thereof;
b) granular component as a fine fraction having a particle size in a range of <0.5 mm, selected from sintered alumina, high-grade α-alumina, zirconium-containing components and mixtures thereof;
c) finely divided Al₂O₃, preferably calcined alumina as a fine fraction having a particle size in a range of <0.5 mm;
d) carbon, preferably graphite and/or carbon black, more preferably a mixture of graphite and carbon black, more preferably still a mixture of graphite and carbon black with a mixing ratio in a range from 1:2 to 2:1, more preferably still a mixture of graphite and carbon black with a mixing ratio of 1:1;
e) metallic aluminum powder (Al powder); and
f) silica sol (silica in aqueous colloidal suspension), preferably silica containing SiO₂ nanoparticles in aqueous colloidal suspension.

The batch of the invention is produced preferably from a dry formulation (preferably comprising constituents a) to e)) by mixing with silica sol (silica in aqueous colloidal suspension; comprising constituent f)). In the dry formulation, the constituents are in chemically unaltered form. Binding of the formulation, based on what is called a sol-gel reaction, takes place only through addition of the silica sol (the silica in aqueous colloidal suspension).

In the context of the present invention, therefore, the batch already contains all the constituents which must be present for production of the refractory material.

The batch comprises the granular component as a coarse fraction having a particle size in a range of 0.5-10 mm, selected from MA spinel, sintered alumina, high-grade α-alumina, brown α-alumina, gray α-alumina, mullite, bauxite, andalusite, Sic, grog, zirconium-containing components and mixtures thereof. The granular component in the course fraction is preferably selected from a group of non-basic components. The use of nonbasic components entails better processing qualities and also a more advantageous cure time after mixing with the silica sol (silica in aqueous colloidal suspension). The reason is that, generally, basic components accelerate the binding process (what is called the sol-gel process).

The batch also comprises the granular component as a fine fraction having a particle size in a range of <0.5 mm. this serves in particular for matrix filling. It has been determined, furthermore, that the granular component in the fine fraction has a positive influence on the flow properties of the batch, especially on casting.

The batch further comprises carbon. Carbon is vital as a source for the formation of the phases formed in situ. In one preferred embodiment, there is a mixture of graphite and carbon black with a mixing ratio in a range from 1:2 to 2:1, more preferably a mixture of graphite and carbon black with a mixing ratio of 1:1. In this way, a very good trade-off is obtained between the physical properties achieved in the refractory material and the processing qualities of the batch. It has been determined here that graphite tends to have a positive influence on the wetting properties (and hence the resistance to infiltration and slag formation), while the more reactive carbon black positively influences the formation of the phases formed in situ.

The batch further comprises metal powder containing aluminum. An example of a metal alloy which can be used is an Al—Si alloy (with around 12% Si) in powder form. Instead of the alloy, however, the batch may comprise a mixture of pulverulent Al-met and Si-met. The batch comprises metallic aluminum powder. The aluminum has the advantageous function in particular of preventing degradation (or oxidation) of carbon. The powder preferably has a particle size <0.1 mm, more preferably <0.075 mm, more preferably still <0.065 mm.

The batch further comprises silica sol (silica in aqueous colloidal suspension), preferably silica containing SiO₂ nanoparticles in aqueous colloidal suspension. This is a suspension of fine amorphous, nonporous and typically spherical silica particles in an aqueous phase. Colloidal silica is not the same as customary (dried) silica (e.g., (dried) fumed silica). The silica sol (the silica in aqueous colloidal suspension) serves in particular as a mixing fluid and binder for the refractory material.

The solids fraction (fraction of SiO₂ particles) in the silica sol (in the aqueous colloidal silica suspension) is preferably in a range from 20% to 50% by weight, more preferably 30% to 50% by weight, based on the total weight of the silica sol.

Replacing a customary silica plus water with a silica sol, namely a silica in aqueous colloidal suspension, is a considerable advantage. The reason is that, when customary silica is used, in certain pH ranges the metal (aluminum) would react with water after the constituents were mixed. This reaction is highly exothermic, and would also give rise to hydrogen gas (H₂). Furthermore, when using aluminum, an aluminum oxide layer (Al₂O₃) would form in the marginal region. These are reactions to avoid. Firstly, the formation of H₂ is disadvantageous on safety grounds; secondly, there would be less aluminum available for the phases formed in situ. Furthermore, however, because of the exothermic reaction and formation of gas, there would also be formation of cracks and layers in the green body. This is prevented by the use of a silica sol-that is, a colloidal silica or a colloidal silica suspension.

The batch may comprise one or more of the following constituents in the following amounts, based on the total fraction of the batch composition:
a) 50-80% by weight, preferably 53-70% by weight, more preferably 55-67% by weight, more preferably still about 59% by weight of granular component as a coarse fraction having a particle size in a range of 0.5-10 mm;
b) 5-35% by weight, preferably 7-30% by weight, more preferably 10-30% by weight, more preferably still about 23% by weight of granular component as a fine fraction having a particle size in a range of <0.5 mm;
c) 0.05-4% by weight, preferably 0.1-3% by weight, more preferably 1-2.5% by weight, more preferably still about 2% by weight of finely divided Al₂O₃;
d) 2-10% by weight, preferably 3-8% by weight, more preferably 3.5-6% by weight, more preferably still about 4.5% by weight of carbon;
e) 2-8% by weight, preferably 3-7% by weight, more preferably 4-6% by weight, more preferably still about 5% by weight of metallic aluminum powder (Al powder);
f) 4-15% by weight, preferably 5-12% by weight, more preferably 6-8% by weight, more preferably still about 7% by weight of silica sol (silica in aqueous colloidal suspension), preferably silica containing SiO₂ nanoparticles in aqueous colloidal suspension, wherein the solids fraction (fraction of the SiO₂ particles) is preferably in a range from 20% to 50% by weight, more preferably 30% to 50% by weight, based on the total weight of the silica sol (the aqueous colloidal silica suspension).

A further subject of the invention is a green body produced from a batch of the invention, preferably a batch as claimed in claim 9 or 10, wherein the green body preferably has an open porosity of about 10-25% by volume, measured according to DIN EN ISO 1927-6, and/or a bulk density in a range of 2.90-3.70 g/cm³, preferably about 2.96 g/cm³, measured according to DIN EN ISO 1927-6.

Also a further subject of the invention is a method for producing a refractory material of the invention, preferably a refractory material as claimed in any of claims 1 to 8, wherein the method comprises the following steps:
i. providing a batch of the invention, preferably as claimed in either of claims 9 and 10;
ii. producing a green body from the batch, and
iii. heating the green body to a temperature of at least 1300° C., preferably to a temperature in a range from 1300° C. to 1750° C.

Here, the providing of the batch of the invention in step i. takes place preferably starting from a dry formulation (preferably comprising constituents a) to e)) which is prepared by mixing with silica sol (silica in aqueous colloidal suspension; comprising constituent f)).

The producing of the green body from the batch in step ii. preferably comprises casting and/or molding.

Yet a further subject of the invention is a refractory material which has an acicular structure and comprises a combination of a first phase, a second phase and a third phase, as follows:

the first phase, which comprises 2-10% by weight C, <5% by weight N, 30-40% by weight O, 50-70% by weight Al and <5% by weight Si, based on the total fraction of the first phase,
the second phase, which comprises >1% by weight C, 3-8% by weight N, 25-35% by weight O, 55-65% by weight Al and <5% by weight Si, based on the total fraction of the second phase,
the third phase, which comprises <7% by weight C, 14-28% by weight N, 10-15% by weight O, 52-63% by weight Al and <20% by weight Si, based on the total fraction of the third phase,
produced by a method of the invention, preferably a method as claimed in claim 12.

Likewise a subject of the invention is the use of a refractory material of the invention, preferably as claimed in any of claims 1 to 8, of a green body produced from a batch as claimed in either of claims 9 and 10 for producing refractory products for steel applications, especially steel ladles, tundishes, perforated blocks, CAS-OB bells, refractory products for the pig iron sector, especially casting products, and/or refractory products for the flow control sector, especially slide gate plates, collector nozzles, shrouded tubes, stoppers, spouts, submerged pipes, inner nozzles, weirs, dams, impact absorbers and other nozzles.

In the context of the invention, products in the flow control sector are understood to be refractory products which make it possible, for example, to obtain liquid metal or steel products or to guide or prevent the flow of such products. Products in the flow control sector require not only good physical properties, such as high strength, but also good processing qualities in the formulation for processing, so as to be able to produce the components, some of which have complex shapes. A key advantage of the flow control products, preferably based on cast products, by comparison with products of isostatic pressing is seen as being a considerable cost reduction.

A further advantage of the invention is therefore that with the batch of the invention and/or the method of the invention it is possible not only to obtain refractory materials having very good physical properties, such as high heat resistance, etc., but also to achieve good processing qualities in the formulation for processing, for the production of relatively complex components, not least by casting.

The invention is now described illustratively through a number of advantageous embodiments, with reference to the appended drawings, in which:

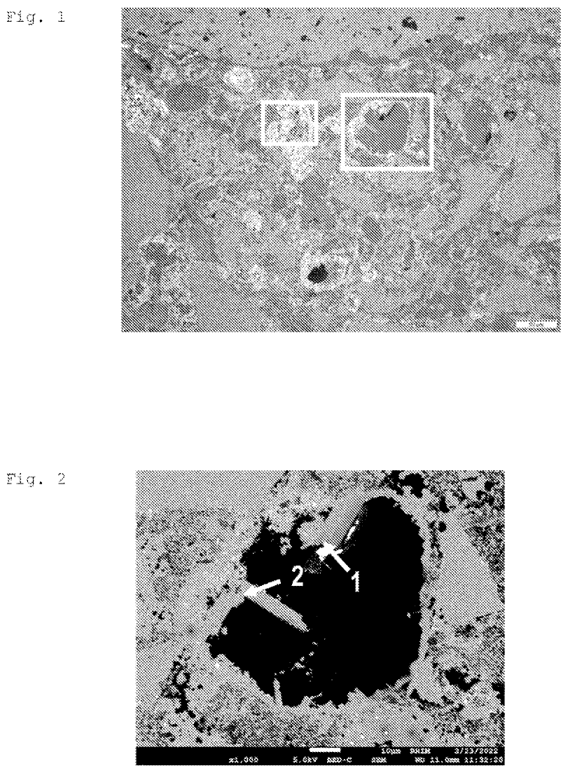

FIG. 1 shows an image of the refractory material of the invention obtained by light microscopy.

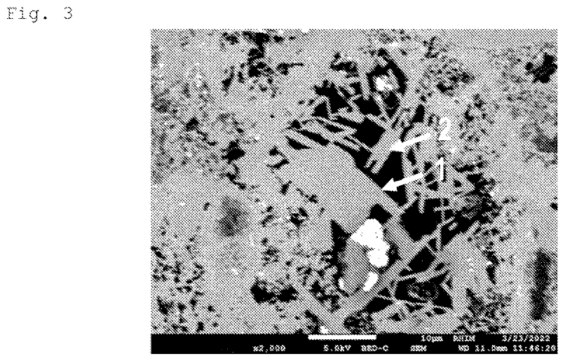

FIG. 2 shows an image of a subregion as shown in FIG. 1, generated via scanning electron microscopy.

FIG. 3 shows an image of a further subregion of the refractory material shown in FIG. 1, generated via scanning electron microscopy.

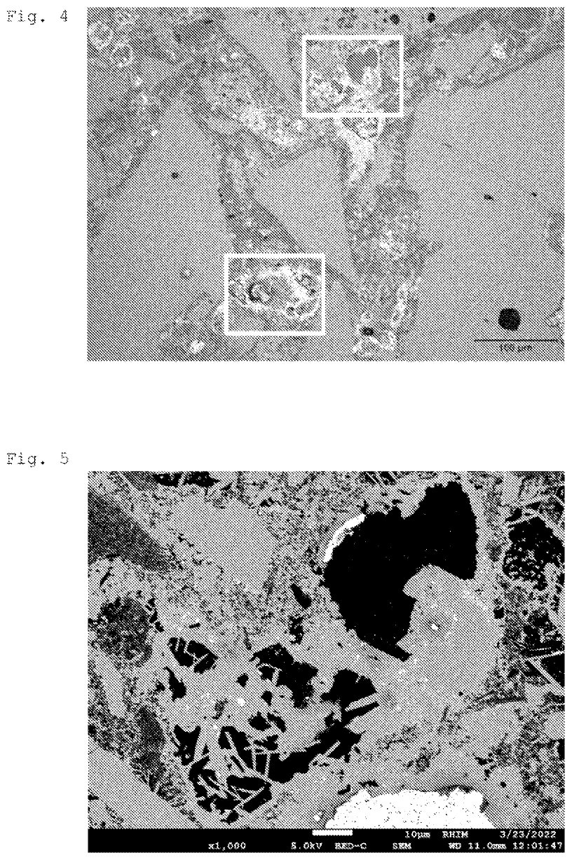

FIG. 4 shows a further image of the refractory material of the invention obtained by light microscopy.

FIG. 5 shows an image of a region of the refractory material of the invention, generated via scanning electron microscopy.

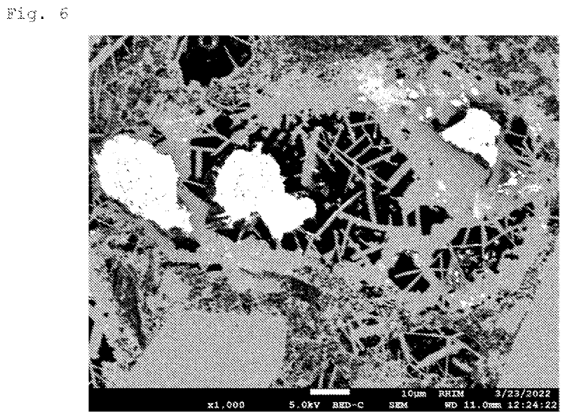

FIG. 6 shows an image of the other region marked in FIG. 4, generated via scanning electron microscopy.

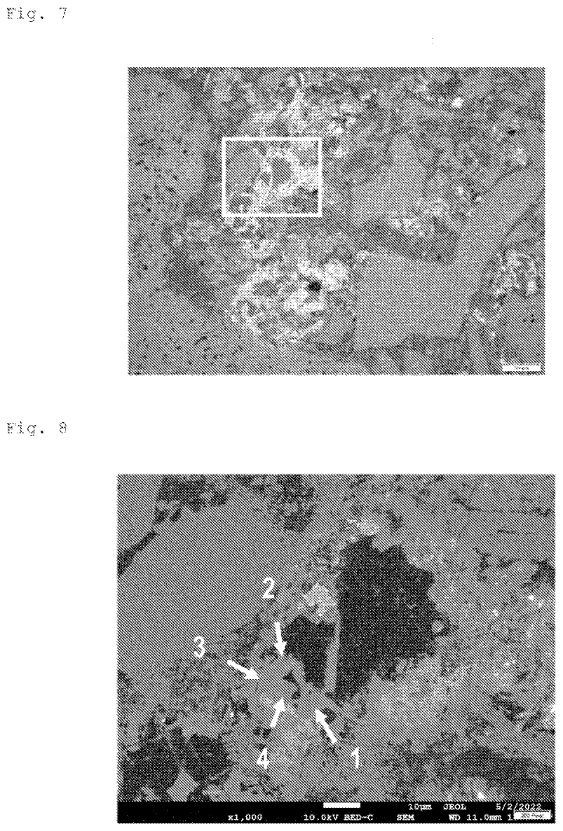

FIG. 7 shows a further image of the refractory material of the invention obtained by light microscopy.

FIG. 8 shows an image of the refractory material from FIG. 7, generated via scanning electron microscopy.

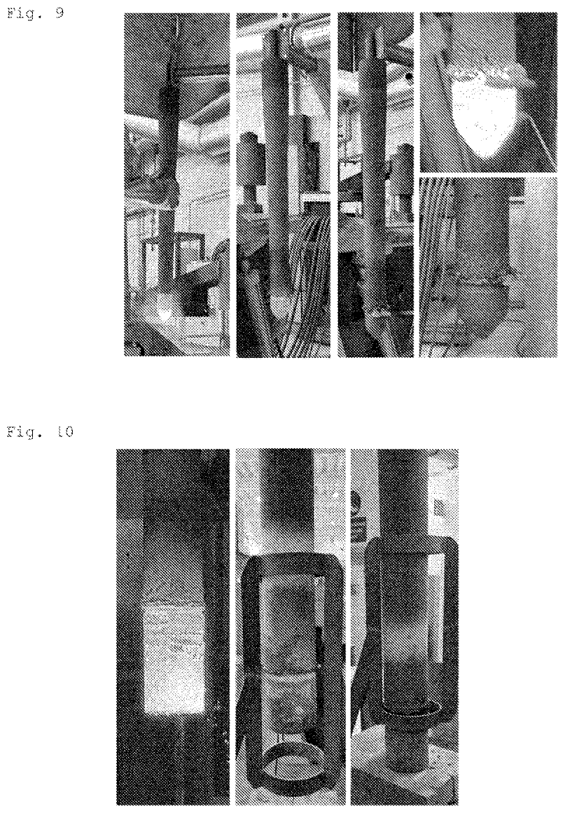

FIG. 9 shows the thermal shock resistance of the refractory material via a stopper cold start test.

FIG. 10 shows the thermal shock resistance of the refractory material via a further test for reusability.

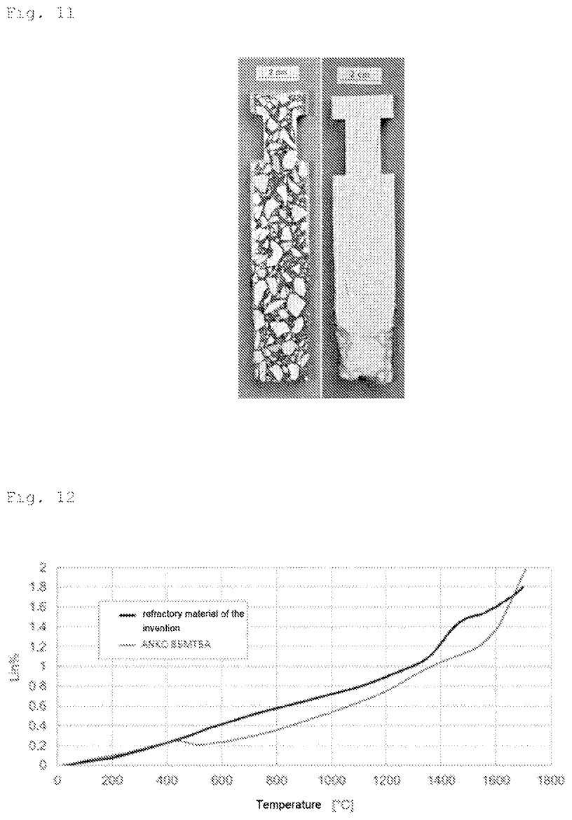

FIG. 11 shows the slag resistance of the refractory material of the invention (left) in comparison to that of a known refractory material (right).

FIG. 12 shows the results of a test with the refractory material of the invention for softening characteristics under pressure (pressure softening).

### PRODUCTION OF A REFRACTORY MATERIAL

Elucidated presently is how a refractory material of the invention can be produced starting from a batch of the invention.

First of all, a batch comprising the following constituents was produced:
58.6 wt % granular component consisting of sintered alumina as a coarse fraction having a particle size in a range of 0.5-10 mm
9.2 wt % sintered alumina (<0.5 mm)
14.0 wt % high-grade α-alumina (<0.2 mm)
1.9 wt % calcined alumina 1A
2.3 wt % graphite, Hunan 80/200 GBK
2.3 wt % thermal black, beaded
4.7 wt % metallic aluminum powder (Al met) (<0.063 mm) 7.0 wt % silica sol (silica in aqueous colloidal suspension), with 40 wt % solids fraction (fraction of the SiO₂ particles), based on the total weight of the silica sol (of the aqueous colloidal silica suspension).

The batch was obtained by mixing a silica sol (silica in aqueous colloidal suspension), containing SiO₂ nanoparticles, with a dry formulation comprising the remaining constituents of the batch. A green body was then produced from this batch by casting. The green body was subsequently heated to a temperature of 1500° C. to give the completed refractory material.

### Physical Properties:

Reproduced below are the physical properties of a green body of the invention and of a refractory material of the invention. Reported for comparison, additionally, are the physical data of a known material not of the invention (DELTEK A115 from RHI Magnesita).

TABLE 1
Physical properties of a green body of the invention, of a refractory
material of the invention and of a comparison material.

| | |
|---|---|
| Material | Comparison |
| of the | material |
| invention | (DELTEK A115) |

Green body after drying at 110° C.,
as per standard DIN EN ISO 1927-5

| | | |
|---|---|---|
| Bulk density (DIN EN ISO | 2.96 | 2.53 |
| 1927-6) [g/cm³] | | |
| Open porosity (DIN EN ISO | 14.0 | 17.3 |
| 1927-6) [vol %] | | |
| Cold crushing strength | 35.0 | — |
| (DIN EN ISO 1927-6) [MPa] | | |
| Cold modulus of rupture | 5.0 | 8.4 |
| (DIN EN ISO 1927-6) [MPa] | | |
| Hot modulus of rupture at | 17.0 | 8.0 |
| 1500° C. in reducing | | |
| atmosphere (with specimens | | |
| cast as per DIN EN ISO 1927-5, | | |
| format 130 × 20 × 20 mm, | | |
| measurement as per ISO | | |
| 5013) [MPa] | | |

After heating to 1000° C. in reducing
atmosphere, as per DIN EN ISO 1927-5

| | | |
|---|---|---|
| Bulk density (DIN EN ISO | 3.0 | — |
| 1927-6) [g/cm³] | | |
| Open porosity (DIN EN ISO | 13.0 | — |
| 1927-6) [vol %] | | |
| Cold crushing strength | 170.0 | — |
| (DIN EN ISO 1927-6) [MPa] | | |
| Cold modulus of rupture | 24.0 | — |
| (DIN EN ISO 1927-6) [MPa] | | |

After heating to 1500° C. in reducing
atmosphere, as per DIN EN ISO 1927-5

| | | |
|---|---|---|
| Bulk density (DIN EN ISO | 3.0 | — |
| 1927-6) [g/cm³] | | |
| Open porosity (DIN EN ISO | 13.0 | — |
| 1927-6) [vol %] | | |
| Cold crushing strength | 140 | — |
| (DIN EN ISO 1927-6) [MPa] | | |
| Cold modulus of rupture | 24.0 | — |
| (DIN EN ISO 1927-6) [MPa] | | |

Thermal conductivity
(as per Dr. Klasse*) [W/mK]:

| | | |
|---|---|---|
| 200° C. | 5.2 | 14.7 |
| 400° C. | 5.2 | 13.7 |
| 600° C. | 4.9 | 12.4 |
| 800° C. | 4.6 | 12.0 |
| 1000° C. | 4.7 | 11.7 |

*Klasse, F.; Heinz, A.; Hein, J.: Vergleichsverfahren zur Ermittlung der Wärmeleitfähigkeit keramischer Werkstoffe [Comparative method for determining thermal conductivity of ceramic materials]. Ber. DKG 34 (1957), pp. 183-189.

Table 1 shows that the refractory material of the invention has high strength. Moreover, the thermal heat conductivity of the refractory material is low by comparison with the known material. The considerably lower thermal heat conductivity of the refractory material of the invention provides better insulation properties and so has a positive influence on the flow properties of the material, as unwanted clogging can be prevented. Clogging is understood as the accumulation of solid constituents and/or particles in a component or spout system, leading possibly to disruption to casting and hence to reduced pouring capacity of the refractory material.

### Measurement Methods:

For the measurements as per DIN EN ISO 1927-6, geometry D as specified in that standard was used.

The refractory material was investigated by light microscopy and scanning electron microscopy. Light-microscopic investigations were performed using a NIKON Eclipse LV150. Analyses using the scanning electron microscope were performed using a JEOL JSM-6460 or using a JEOL JSM-7900F scanning electron microscope.

The composition of the individual phases was determined via scanning electron microscopy with an excitation voltage of 10 kV and a probe current of 1 nA, using an energy-dispersive detector. The scanning electron microscope images were generated using a BSE detector.

FIG. 1 shows an image of a refractory material of the invention obtained by light microscopy, in which the acicular structure of the material is evident. In particular, regions that can be seen include those with structures having a holelike or circular appearance, in which the acicular structures of the material are preferentially formed. The needles preferably have a low thickness in a range of 0.01-8 μm, more preferably 0.2-5 μm. It is assumed that the fine needles which form in many regions are very likely responsible for the very good thermal shock resistance of the refractory material. It is additionally assumed that the circular structures in the refractory material may prevent crack propagation.

FIG. 2 shows an image, generated via scanning electron microscopy, of the refractory material from FIG. 1, with FIG. 2 depicting the right-hand region of those marked in FIG. 1. The acicular structure of the material is evident even more markedly from FIG. 2. FIG. 2 shows the regions 1 and 2, which correspond to the first phase, more particularly the Al₄O₄C phase.

FIG. 3 likewise shows an image, generated via scanning electron microscopy, of the refractory material from FIG. 1. The detail shown in FIG. 3 corresponds to the left-hand region of those marked in FIG. 1. The detail shows a structure of circular appearance at whose surface or in whose center an acicular structure has formed in situ. In the regions 1 and 2 shown in FIG. 3, there are phases present which correspond to the second phase, more particularly the Al₂₈C₆N₆O₂₁ phase.

FIG. 4 shows a further image of the refractory material of the invention, obtained via light microscopy, in which further regions of holelike structure are evident, in which the acicular structures of the material have formed in situ.

FIG. 5 in this connection shows an image, generated via scanning electron microscopy, of the top region of those marked in FIG. 4. In this region as well, the refractory material has an acicular structure. In the region 1 shown in FIG. 5 there is a phase present which corresponds to the second phase, more particularly the Al₂₈C₆N₆O₂₁ phase. Furthermore, FIG. 5 also shows the region 2, in which a phase is present which corresponds to the third phase, more particularly the SiAl₆O₂N₆ phase.

FIG. 6 likewise shows an image, generated via scanning electron microscopy, of the refractory material from FIG. 4. The detail shown in FIG. 6 corresponds to the lower region of those marked in FIG. 4. In this region, the refractory material likewise has an acicular structure. The detail shows a structure of circular appearance at whose surface or in whose center a multiplicity of fine needles have formed. In the region 1 shown in FIG. 6 there is a phase which corresponds to the second phase, more particularly the Al₂₈C₆N₆O₂₁ phase. Furthermore, FIG. 6 shows the region 2, in which a phase is present which corresponds to the third phase, more particularly the SiAl₆O₂N₆ phase. Additionally, FIG. 6 also shows the region 3, in which a phase is present which corresponds to the fourth phase, more particularly the AlN phase.

FIG. 7 shows a further image of the refractory material of the invention, obtained by light microscopy, from which a circular region is evident in which the acicular structure of the refractory material is present again.

FIG. 8 in turn shows an image, generated via BSE scanning electron microscopy, of the refractory material with acicular structure that is represented in FIG. 7. FIG. 8 shows the regions 1 and 3, which correspond to the first phase, more particularly the Al₄O₄C phase. Additionally, FIG. 8 likewise shows the regions 2 and 4, which correspond to the third phase, more particularly the SiAl₆O₂N₆ phase.

### Tests for Thermal Shock Resistance:

The tests below tested the thermal shock resistance of the refractory material of the invention.

a. Stopper Cold Start Test:

In a first test, the refractory material, in the form of a stopper, was immersed directly without preheating into liquid steel at a temperature of 1650° C. The refractory material was subsequently removed from the liquid steel and cooled to room temperature.

This procedure was repeated in three cycles.

The refractory material of the invention exhibits very good thermal shock resistance (see FIG. 9).

b. Test for Reusability:

In a further test, the refractory material, in the form of a steel ladle, this time with preheating, was immersed into liquid steel at a temperature of 1650° C. The refractory material was subsequently removed from the liquid steel and cooled to room temperature.

This procedure was repeated in three cycles.

In this test as well, the refractory material of the invention exhibited very good thermal shock resistance (see FIG. 10).

### Test for Slag Resistance:

The slag resistance is the capacity of the refractory material to withstand the detrimental effect of molten slags. The slag resistance is ascertained through the loss in volume or loss in weight of a refractory material when exposed to slag.

In the present test, the refractory material of the invention was tested against both an acidic (C/S=0.8) and a basic (C/S=3.2) slag composition. As well as the refractory material of the invention (FIG. 11, left), a known refractory material for steel ladles (COMPRIT 185HMV from RHI Magnesita) (FIG. 11, right) was also tested, as a comparison material.

Not least in comparison with the known refractory material for steel ladles (comparison material COMPRIT 185HMV from RHI Magnesita), the refractory material of the invention exhibited very good slag resistance (see FIG. 11).

Test for pressure softening (softening characteristics under pressure):

Furthermore, a test for the softening characteristics under pressure (pressure softening) was carried out with the refractory material.

For this test, firstly the refractory material of the invention and secondly a known refractory material (ANKO 85MR5A from RHI Magnesita) as a comparison material were used.

The test was carried out with a sample cast as per DIN EN ISO 1927-5. The sample was dried as per DIN EN ISO 1927-5 at a temperature of 110° C.

Test specimen: cylinder (height (h): 50 mm, diameter (d): 40 mm, internal hole: 16 mm, measurement method as per ISO 5013)

The measurements for the softening characteristics under pressure (pressure softening) were carried out as per DIN EN ISO 1893. In this case an applied load of 0.2 MPa and a heating rate of 5° C./min in reducing atmosphere were selected. The result obtained was a T0.5 of >1700° C. This figure is the temperature at which the maximum thermal expansion of the specimen has decreased by 0.5%. The maximum temperature of the measurement is limited to 1700° C.

For the material of the invention, in contrast to be known refractory material, no softening was found up to a temperature of 1700° C. (FIG. 12).

Test for Measuring the Thermal Conductivity as Per Dr. Klasse:

The thermal conductivities reported in Table 1 for the material of the invention and for the comparison material (DELTEK A115 from RHI Magnesita) were determined by the method of Dr. Klasse (Klasse, F.; Heinz, A.; Hein, J.: Vergleichsverfahren zur Ermittlung der Wärmeleitfähigkeit keramischer Werkstoffe [Comparative method for determining thermal conductivity of ceramic materials]. Ber. DKG 34 (1957), pp. 183-189). The values reported for 1000° C. were extrapolated here.

1. A refractory material treated thermally at a temperature of at least 1300° C., to have an acicular structure and to comprise a combination of a first phase, a second phase and a third phase, wherein:
the first phase, which comprises 2-10% by weight C, <5% by weight N, 30-40% by weight O, 50-70% by weight Al and <5% by weight Si, based on the total fraction of the first phase;
the second phase, which comprises 1-7% by weight C, 3-8% by weight N, 25-35% by weight O, 55-65% by weight Al and <5% by weight Si, based on the total fraction of the second phase; and
the third phase, which comprises <7% by weight C, 14-28% by weight N, 10-15% by weight O, 52-63% by weight Al and <20% by weight Si, based on the total fraction of the third phase.

2. The refractory material of claim 1, wherein the first phase comprises Al₄O₄C or consists of Al₄O₄C.

3. The refractory material of claim 1, wherein the second phase comprises Al₂₈C₆N₆O₂₁ or consists of Al₂₈C₆N₆O₂₁.

4. The refractory material of claim 1, wherein the third phase comprises a compound selected from SiAl₆O₂N₆, SiAl₅O₂N₅, SiAl₄O₂N₄, Si₃Al₇O₃N₉ and mixtures thereof or consists of a compound selected from SiAl₆O₂N₆, SiAl₅O₂N₅, SiAl₄O₂N₄, Si₃Al₇O₃N₉ and mixtures thereof.

5. The refractory material of claim 1, wherein the refractory material comprises a fourth phase, wherein the fourth phase comprises <5% by weight C, 26-36% by weight N, <8% by weight O, 56-66% by weight Al and <5% by weight Si, based on the total fraction of the fourth phase.

6. The refractory material of claim 1, wherein the acicular structure comprises needles with a length in a range of 0.1-50 μm, and/or with a thickness in a range of 0.01-8 μm, measured via scanning electron microscopy with an excitation voltage of 10 kV and a probe current of 1 nA.

7. The refractory material of claim 1, wherein a minimal ratio of lengths to thicknesses at least for some of the needles is at least 4:1.

8. The refractory material of claim 1, wherein a fraction of the phases with acicular structure is at least 0.01% by weight, based on the total fraction of the refractory material.

9. A batch for producing a refractory material of claim 1, wherein the batch comprises the following composition:
a) a granular component as a coarse fraction having a particle size in a range of 0.5-10 mm, wherein the granular component is selected from MA spinel, sintered alumina, high-grade α-alumina, brown α-alumina, gray α-alumina, mullite, bauxite, andalusite, SiC, grog, zirconium-containing components and mixtures thereof;
b) a granular component as a fine fraction having a particle size in a range of <0.5 mm, selected from sintered alumina, high-grade α-alumina, zirconium-containing components and mixtures thereof;
c) a finely divided Al₂O₃;
d) carbon;
e) metallic aluminum powder; and
f) silica sol.

10. The batch of claim 9, wherein one or more of the following constituents are present in the following amounts, based on the total fraction of the batch composition:
a) 50-80% by weight of granular component as a coarse fraction having a particle size in a range of 0.5-10 mm;
b) 5-35% by weight of granular component as a fine fraction having a particle size in a range of <0.5 mm;
c) 0.05-4% by weight of finely divided Al₂O₃;
d) 2-10% by weight of carbon;
e) 2-8% by weight of metallic aluminum powder; and
f) 4-15% by weight of silica sol.

11. A green body produced from a batch of claim 9, wherein the green body has one or more of the following properties:
an open porosity of about 10-25% by volume, measured according to DIN EN ISO 1927-6; and
a bulk density in a range of 2.90-3.70 g/cm³, measured according to DIN EN ISO 1927-6.

12. A method for producing the refractory material of claim 1, wherein the method comprises the following steps:
i. providing a batch, wherein the batch comprises the following composition:
a) a granular component as a coarse fraction having a particle size in a range of 0.5-10 mm, wherein the granular component is selected from MA spinel, sintered alumina, high-grade α-alumina, brown α-alumina, gray α-alumina, mullite, bauxite, andalusite, SiC, grog, zirconium-containing components and mixtures thereof;
b) a granular component as a fine fraction having a particle size in a range of <0.5 mm, selected from sintered alumina, high-grade α-alumina, zirconium-containing components and mixtures thereof;
c) a finely divided Al₂O₃;
d) carbon;
e) metallic aluminum powder; and
f) silica sol;
ii. producing a green body from the batch; and
iii. heating the green body to a temperature of at least 1300° C.

13. (canceled)

14. The refractory material of claim 1, wherein the refractory material is treated thermally at a temperature of 1300° C. to 1750° C.

15. The refractory material of claim 5, wherein the fourth phase comprises AlN or consists of AlN.

16. The refractory material of claim 6, wherein the acicular structure comprises needles with a length in a range of 2-30 μm.

17. The refractory material of claim 6, wherein the acicular structure comprises needles with a thickness in a range of 0.2-5 μm.

18. The refractory material of claim 8, wherein the fraction of the phases with acicular structure is 0.1% by weight, based on the total fraction of the refractory material.

19. The batch for producing a refractory material of claim 9, wherein the finely divided Al₂O₃ is calcined alumina as a fine fraction having a particle size in a range of <0.5 mm; the carbon is a mixture of graphite and carbon black with a mixing ratio in a range from 1:2 to 2:1; and the silica sol is silica containing SiO₂ nanoparticles in aqueous colloidal suspension.

20. The batch of claim 10, wherein one or more of the following constituents are present in the following amounts, based on the total fraction of the batch composition:
a) 55-67% by weight of granular component as a coarse fraction having a particle size in a range of 0.5-10 mm;
b) 10-30% by weight of granular component as a fine fraction having a particle size in a range of <0.5 mm;
c) 1-2.5% by weight of finely divided Al₂O₃;
d) 3.5-6% by weight of carbon;
e) 4-6% by weight of metallic aluminum powder; and
f) 6-8% by weight of silica containing SiO₂ nanoparticles in aqueous colloidal suspension, wherein the solids fraction is in a range from 30% to 50% by weight, based on the total weight of the aqueous colloidal silica suspension.

21. The green body produced from a batch of claim 11, wherein the green body has a bulk density of about 2.96 g/cm³, measured according to DIN EN ISO 1927-6.
